(19) United States
(12) Patent Application Publication
(10) Pub. No.: US 2019/0220537 A1
(43) Pub. Date: Jul. 18, 2019

(54) CONTEXT-SENSITIVE METHODS OF SURFACING COMPREHENSIVE KNOWLEDGE IN AND BETWEEN APPLICATIONS

(71) Applicant: Microsoft Technology Licensing, LLC, Redmond, WA (US)

(72) Inventors: Bernhard S. J. KOHLMEIER, Seattle, WA (US); Douglas Maxwell TAYLOR, Kirkland, WA (US); Victor POZNANSKI, Sammamish, WA (US)

(21) Appl. No.: 15/871,902

(22) Filed: Jan. 15, 2018

(51) Int. Cl. G06F 17/30

(52) U.S. Cl. CPC G06F 17/30528; G06F 17/30595; G06F 17/30554; G06F 17/3053; G06F 17/30867

(57) ABSTRACT

Context from a content creation application is used to focus both on the types of files and the types of content searched by a search application, as well as the type of results provided to the content creation application for use by the user, instead of simply improving relevancy of a result. A query of structured, contextual information can be formulated based on the discernable intent and context information provided with the request. Queries are sent to search applications to search appropriate file types and/or content types. Context-sensitive results returned from the search application(s) can be grouped by performing a clustering process according to semantic similarity in order to group the context-sensitive results into groups, and selected ones of the context-sensitive results can be provided to a user.

### BACKGROUND

Content creation applications are software applications in which users can create text and/or image-based content in digital form. Some content creation applications support collaboration. In most cases, content creation applications include tools for authoring new content and editing existing content. Examples of content creation applications include, but are not limited to, note-taking applications such as MICROSOFT ONENOTE and EVERNOTE, freeform digital canvases such as GOOGLE JAMBOARD and MICROSOFT Whiteboard, word processing applications such as MICROSOFT WORD, GOOGLE DOCS, and COREL WORDPERFECT, spreadsheet applications such as available in GOOGLE DOCS and MICROSOFT EXCEL, presentation applications such as MICROSOFT POWERPOINT and PREZI, as well as various productivity, computer-aided design, blogging, and photo and design software.

When creating content, users often pull information and other content from a variety of sources. Often users query search engines or specific resources (e.g., Wikipedia) to find content available from the web. Similarly, users may search enterprise resources, including their own files, to find content that can be reused. The searching of the multiple resources—even if done within a content creation application—can still take significant time and bandwidth.

### BRIEF SUMMARY

Context-sensitive methods of surfacing comprehensive knowledge in and between applications are described. Context from a content creation application is used to focus both on the types of files and content searched as well as the type of results provided to the content creation application for use by the user, instead of simply improving relevancy of a result.

Context-sensitive methods can include, based on an implicit or explicit intent of a user, receiving a request for context-sensitive search results, the request comprising context information. In response to the request, a query can be formulated in a standardized format with elements available for parameters associated with context, the query including items of the context information in appropriate elements of the query. Parameters associated with context can include, but are not limited to an IP location, what is selected in a canvas, application, state and complexity of a document, objects on the canvas, user organization, command history, topic history, and document history.

The query can be sent to one or more search applications to search appropriate file types and content types based on the context. Results returned from the search applications can be aggregated, ranked, and grouped to identify selected results to send to the source of the request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates conceptual operation of context-sensitive surfacing of comprehensive knowledge.

FIG. 2 illustrates a context-sensitive method for surfacing comprehensive knowledge in and between applications.

FIG. 3A illustrates an example operating environment for context-sensitive surfacing of comprehensive knowledge in and between applications.

FIG. 3B illustrates a query for context-sensitive search.

FIG. 3C illustrates a query for a context-relevant search.

FIG. 4 illustrates an example scenario for a word processing application.

FIG. 5 illustrates an example scenario for a presentation application.

FIG. 6 illustrates an example scenario for a spreadsheet application.

FIG. 7 illustrates components of a computing device that may be used in certain embodiments described herein.

FIG. 8 illustrates components of a computing system that may be used in certain embodiments described herein.

### DETAILED DESCRIPTION

Context-sensitive methods of surfacing comprehensive knowledge in and between applications are described. The described systems and techniques can provide improved Internet and enterprise search functionality.

Context from a content creation application can be used to focus both on the types of files and the types of content searched by a search application, as well as the type of results provided to the content creation application for use by the user, instead of simply improving relevancy of a result. File types include, but are not limited to, database files, document files (e.g., PDF, .doc), graphics files (e.g., PNG, GIF), computer-aided design (e.g., SPICE netlists, CAD), presentation files (e.g., PPT, PEZ), and video files (e.g., MPEG-4). Content types include, but are not limited to, rich text (or other structured data), text, video, and images. Content types may be considered categories of items.

A search application refers to an application that can search an index of content from one or more sources, search the content directly, or search both the index and the content. Examples of search applications include search engines and enterprise search systems. Also intended to be included in the scope of a search application include virtual assistant search capabilities, such as provided by Microsoft Cortana, Amazon Alexa, and the like, that may leverage search engine services.

Search applications may take myriad forms. A familiar kind of search application is a web search engine such as, but not limited to, MICROSOFT BING and GOOGLE. A search service of a search application may also be built to optimize for the queries and context patterns in an application so that retrieval of information may be further focused and/or improved. Sometimes, an “intranet” search engine implemented on an internal or private network may be queried as a search application; an example is Microsoft FAST Search. A custom company knowledge-base or knowledge management system, if accessible through a query, may be considered a search application. In some implementations, a custom database implemented in a relational database system (such as MICROSOFT SQL SERVER) that may have the capability to do textual information lookup may be considered a search application. A search application may access information such as a structured file in Extended Markup Language (XML) format, or even a text file having a list of entries.

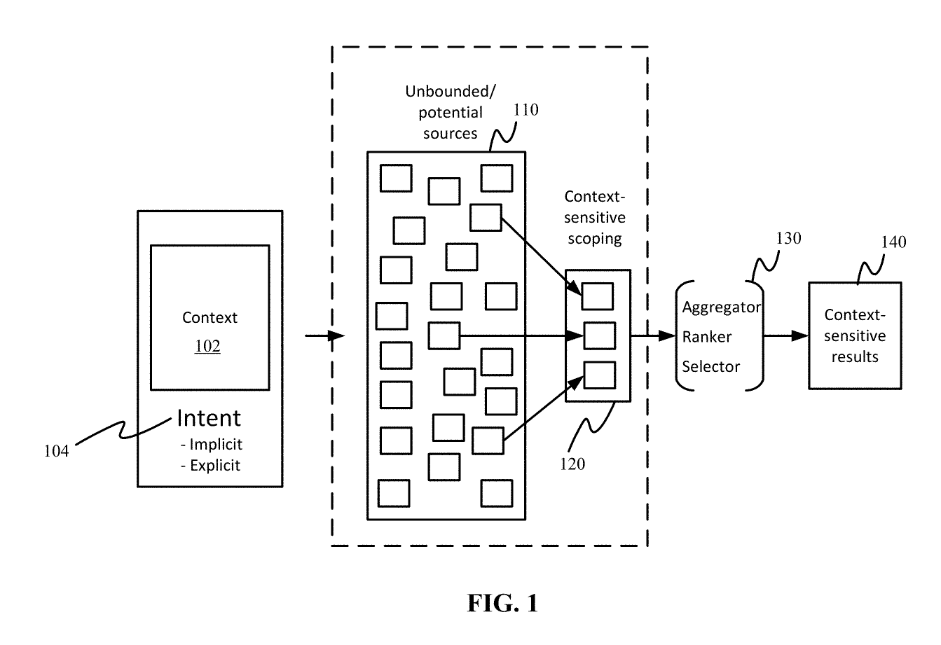

FIG. 1 illustrates conceptual operation of context-sensitive surfacing of comprehensive knowledge. Referring to FIG. 1, conceptually, context-sensitive surfacing of comprehensive knowledge in and between applications involves taking context 102 and intent 104 to scope a set of sources 110 from all known and/or available sources to a scoped set 120, which is searched for relevant content. The process by which the context 102 and intent 104 are used to scope the set of sources 110 (scoped to certain types of sources, certain types of files, and/or certain types of content) includes formulating queries in a standardized format with elements available for parameters associated with the context 102. The results of the search of the scoped set 120 can then be further acted upon (by aggregating, ranking, and grouping) 130 based on the context (and intent) to obtain results 140 expected to be most relevant to the user.

Context-sensitive surfacing of comprehensive knowledge involves taking context 102 and discernable intent 104 to perform context-sensitive scoping of the sources that are searched for relevant content. That is, the process can be conceptualized as two steps—one step is to scope sources (to be searched) based on the context and the other step is to select the results of the search to surface to the user based on the context. Context such as enterprise context, user context, and the like can be used to scope sources from all available sources of content 110. Intent 104 may be used to further scope the sources, and, in general, is used to find results from the sources that may be relevant.

Not all available sources would necessarily apply to address a user's intent. For example, if a user's intent is to “reuse a slide”, a relevant source to search would likely be an enterprise cloud depository and, since the intent calls for document recall, the search would be of content the user has seen before. The query, with its standardized format, is intended to be able to convey the types of sources and the types of files and types of content to search. The type of source in a scoped source search can also be of a “trusted source” type.

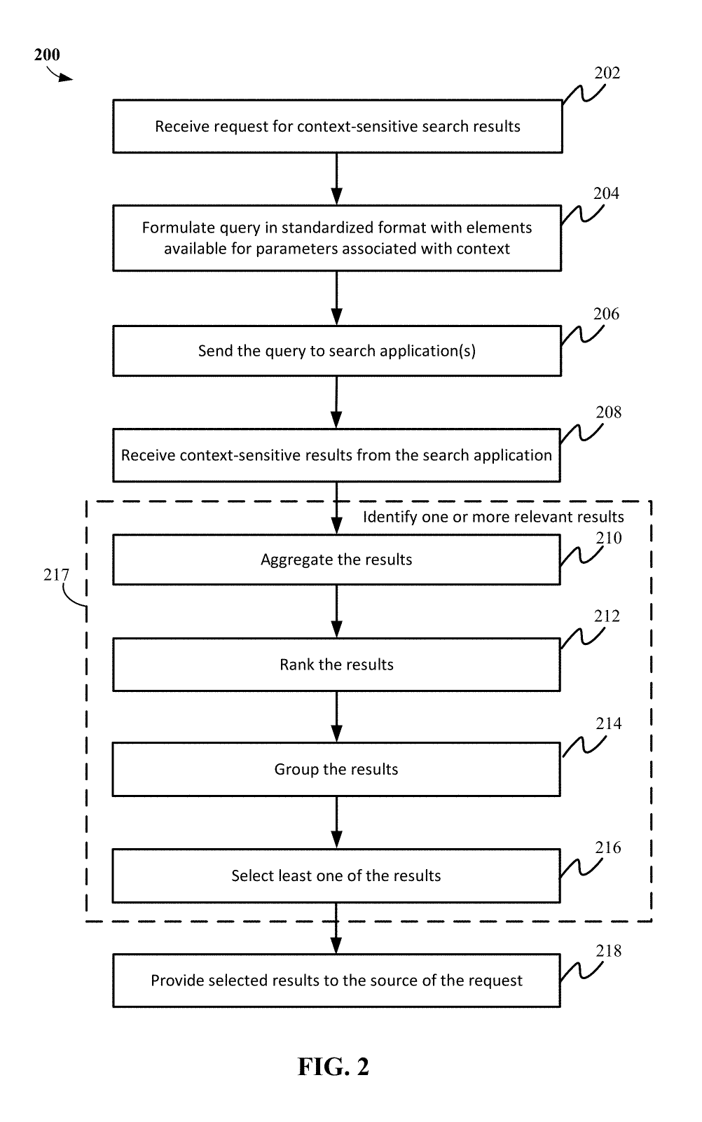

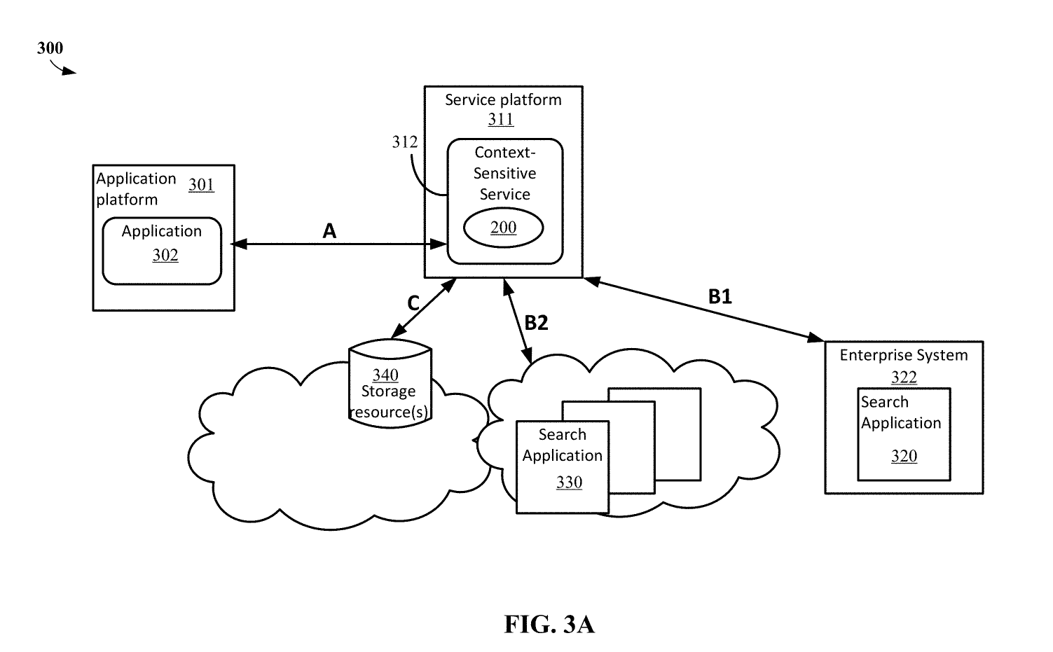

FIG. 2 illustrates a context-sensitive method for surfacing comprehensive knowledge in and between applications. FIG. 3A illustrates an example operating environment for performing context-sensitive methods of surfacing comprehensive knowledge in and between applications. FIG. 3B illustrates a query for context-sensitive search; and FIG. 3C illustrates a query for a context-relevant search. In FIG. 3A, the example operating environment 300 shows service architecture and certain associated operational scenarios demonstrating various aspects of the described context-sensitive methods. The service architecture includes application platform 301 and service platform 311. Local application 302 is executed within the context of application platform 301, while service 312 is hosted by and runs within the context of service platform 311. Also included in the operating environment can be, for example, search application 320 available on an enterprise system 322, public search applications 330, and storage resource(s) 340.

Referring to FIG. 2, process 200 can be carried out by a context-aware service, such as described with respect to context-aware service 312 of FIG. 3A. The context-aware service receives (202) a request for context-sensitive search results. The request includes context information (e.g., context 102). The request may also include explicit query terms or a natural language statement from which a discernable intent of the search is identified.

The request for context-sensitive search results can be from an application (e.g., communication A with application 302 of FIG. 3A) or, in some cases, when the context-aware service is integrated with a search engine or other search application, the request may be received via an input field of the search application (e.g., entered by a user).

When the request is from an application, the request may be initiated by explicit or implicit action by a user of the application, and the context provided with the request is communicated by the application (and may include information available by additional services to which the application has access, such as for obtaining certain history information, as well as information available by the communication channel, such as IP address or location). When the request is via an explicit input, the context provided with the request may be a natural language statement of intent regarding the application or project the search results are for or specific command or query language made available by the search application. The information such as user location and IP address may be obtained from the web browser or other mechanism.

Once the request is received, the context-aware service formulates (204) a query in a standardized format with elements available for parameters associated with the context. The creation of the query can transform the context information into structured, contextual information, making it possible to have a common representation for the data. The parameters associated with the context, and which can have elements in the standardized format, can include, but are not limited to, a text string, IP location, what has been selected within a canvas of an application, the particular application being used, state of a document (e.g., has title slide, has bulleted list, empty), complexity of the document (e.g., amount of formatting, object types, rich text, etc.), objects on the canvas (e.g., video, table, image, ink, animation), the organization the user belongs to (can also include type of organization and type of industry), command history of the user, topic history of the user, document history of the user, and a combination thereof.

When formulating the query, items of the context information are placed in appropriate elements of the query. When there is an expressed query term or natural language statement, such information can be included as part of the query either in its current format or after processing to identify terms from the information (as well as possible additional terms) for the query/ies itself.

The context-aware service then sends (206) the query to one or more search applications to search appropriate sources, file types, and/or content types. The query may be different depending on the capabilities of the search applications (e.g., some search applications may require additional structure). As shown in FIG. 3A, service 312 and search applications 320, 330 conduct B communications (e.g., B1, B2). The B communications refer to the communications providing queries that can be understood by a search application. In some cases, the service 312 can have a description of the search applications that can respond to a particular context (and the particular query formulation to use). Both enterprise search applications 320 and public search applications 330 can receive the queries formulated by the context-sensitive service. Queries provide contextual information directly or indirectly from the A communication (providing content and context for determining a user's intent regarding a context-sensitive search) in a standardized format with elements available for parameters associated with the context.

Returning to FIG. 2, after receiving (208) results from the one or more search applications, the context-aware service aggregates (210), ranks (212), groups (214), and selects (216) at least one of the results. The aggregating (210), ranking (212), grouping (214) and selecting (216) may be considered to be part of identifying (217) one or more relevant results. The at least one selected result can be provided (218) to the source of the request (e.g., also shown as A communications in FIG. 3A; however, in some cases, the source of a request may be tied to a user's account and therefore may be available on different devices than that used to specify the request).

The aggregating (210) of the results is carried out to combine results that can come in from different sources and search applications. The ranking (212) of the received results may be performed based on relevancy of the content of the results to the discernable intent of the request. This may be accomplished based on confidence values associated with each result. In some cases, the context information can be used to facilitate the ranking based on relevancy. In some cases, the context information can contribute to improved ranking of the results by assigning a higher ranking to content of certain file types or content types or characteristics (e.g., formatting). The grouping (214) can further improve the applicability of the results, and can include semantically grouping the content by, for example performing a clustering process according to semantic similarity. The selecting (216) of at least one result can then be performed based on the ranked and grouped results. For example, the top 1-5 results of each group could be provided for display to the user. As another example, the top 1-5 results of the group considered most relevant can be provided.

Communications not yet mentioned with reference to process 200 and operating environment 300 shown in FIG. 3A include C communications. The context-sensitive service 312 can conduct C communications with storage resource(s) 340 to store feedback/community data, which may be used to improve and/or train the ranking, grouping, and/or selection operations of the service 312 among other things.

Turning briefly to FIGS. 3B and 3C, in some cases, the context-sensitive service 312 can send a query for a contextual search instead of or in addition to a query for a context-sensitive search. As illustrated in FIG. 3B, for a context-sensitive search, service 312 can send a query 351 to one or more search applications 320, 330. The one or more search applications 320, 330 can then query, for example, identified file types and/or content types from the query 351 to return content 352 related to file type and/or content type (or having other appropriate characteristics), providing contextually relevant content. For a comparison, as illustrated in FIG. 3C, the service 312 can send a query 361 for a contextual search to one or more search applications 320, 330. The query 361 may include terms generated using the context received with communication A or may provide some context information in the case that a search application generates additional terms for the search. In the contextual search, all the available resources may be searched by the search applications 320, 330, and content 362 related to the context may be returned. In both cases, it can be seen that although context is used to conduct the searches, the context-sensitive search uses the context in a different manner than the contextual search. In some cases, both a context-sensitive search and contextual search may be conducted by the search applications.

Obtaining contextually relevant content (contextual and context-sensitive) involves context and explicit or implicit intent of a user. Explicit and implicit intent can also be leveraged for generating the query terms itself.

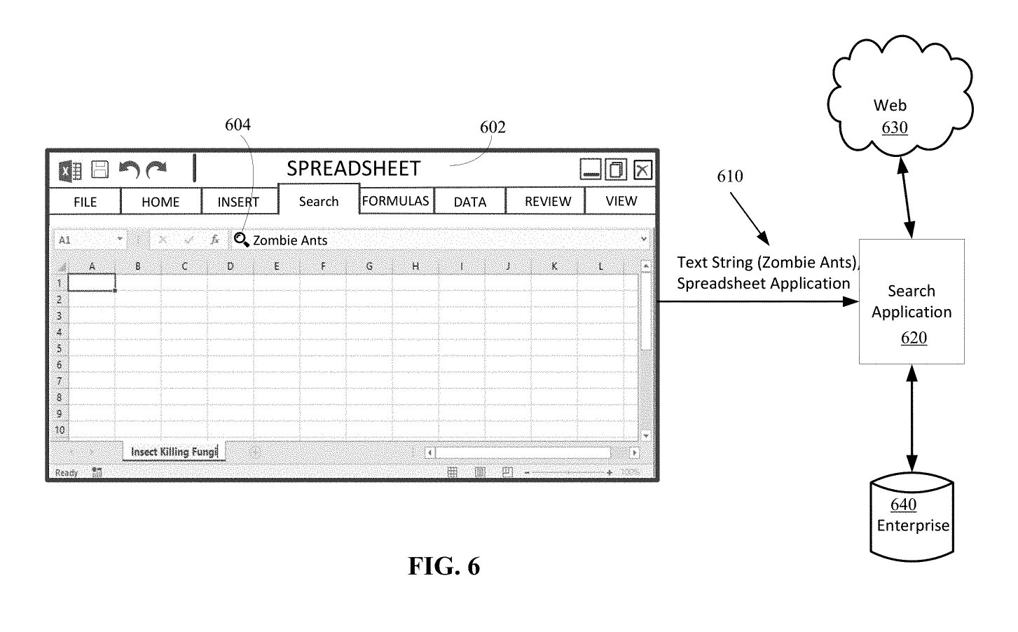

For example, a context-sensitive query may be initiated by a user interacting with an application on client device, such as device 700 of FIG. 7. For example, content in the form of a document (including any format type document), article, picture (e.g., that may or may not undergo optical character recognition), book, and the like may be created or consumed (e.g., read) by a user via the application running on the client device. A user may interact with the content and/or an interface to application to indicate a request for context-sensitive results is desired. As one example of an indication of a request for context-sensitive results, a user can indicate an initial selection of content for context-sensitive results. A user may indicate an interest in certain content in, for example, a document, email, notes taken in a note-taking application, e-book, other electronic content, or the physical world through Internet of Things. The indication of interest does not require the entering of search terms into a search field. Of course, in some implementation, a search box may be available as a tool in the application so that a user may enter terms or a natural language expression indicating a topic of interest.

Interaction by the user indicating the initial content selection may take myriad forms. The input indicating an initial content selection can include, but is not limited to, a verbal selection (of one or more words, phrases, or objects), contact or contact-less gestural selection, touch selection (finger or stylus), swipe selection, cursor selection, encircling using a stylus/pen, or any other available technique that can be detected by the client device (via a user interface system of the device). A computing device capable of detecting voice commands can be used to recognize a spoken command to initially select content for contextual insights. It should also be noted that many other user interface elements, as diverse as drop-down menus, buttons, search box, or right-click context menus, may signify that the user has set an initial content selection.

In some implementations, context-sensitive queries may initiate without an active selection by a user (e.g., an implicit form of intent). For example, the user may, for instance, utilize a device which is capable of detecting eye movements. In this scenario, the device detects that the user's eye lingers on a particular portion of content for a length of time, indicating the user's interest in selecting the content. In one such scenario, the input for initial text selection may be discerned from passive, rather than active, interactions by the user. For example, while the user is scrolling through the text rendered by an application, a paragraph on which the user lingers for a significant time might constitute an initial content selection. As an additional example, if the client device allows the user's eye movements to be tracked, words, phrases, images, or other objects on which the user's eye lingers may form the input for initial content selection. In yet another example, the entire document, window, or page may be considered to be selected based on a passive interaction.

As an example scenario, an enterprise system user may come across an acronym that they do not know. The user may submit an explicit intent of defining the acronym. The context of the user's organization and that the user is searching for an acronym can be used to first scope the sources being searched to those that include acronyms. For example, the system can determine that acronyms are most commonly found in an enterprise repository as well as in government, scientific, and research sources. Thus, the context can be used to determine the type and/or source of results that will be returned to the user, and those sources can be searched for results relevant to the particular acronym the user does not know. The search results are then aggregated into semantic groupings. For example, if the acronym was DSSM, inside the company, there may be sources that indicate that DSSM stands for, for example, Design for Six Sigma Manufacturing. On the web, there may be two top definitions: Defense Superior Service Medal and Deep Structured Semantic Model. The search application would return results containing all three of the uses of DSSM and the service would generate semantic groupings to assign results about each of the three DSSM topics into their respective group.

There are a number of different ways to present these results. For example, the service may decide which is the most likely of the three groupings to be relevant and only provide those. As another example, the service may determine that a characteristic of the content is most relevant, for example content that includes definitions, and provide the content with definitions from each group to the user.

Current search engines let a user manually select the type of content being searched. For example, BING and GOOGLE support separately searching images, maps, and news. The described system automatically determines what type of content to search based on the context. That is, the application the user is in and the content within the application, as well as other context, becomes part of the search query. For example, if the user wants to understand the definition of an acronym, the context of what the user is doing and what organization the user belongs to would potentially identify the sources to search (e.g., an enterprise source). As another example, if an image is selected within the document, the context of an image being selected can become part of the query and the sources that are searched can be those with images. A similar result could occur if the application itself is one where users include images (e.g., STORIFY).

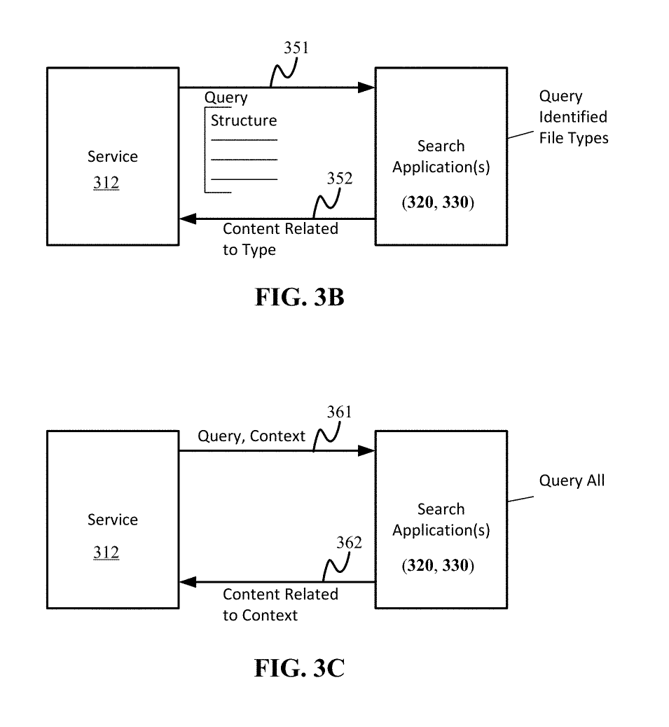

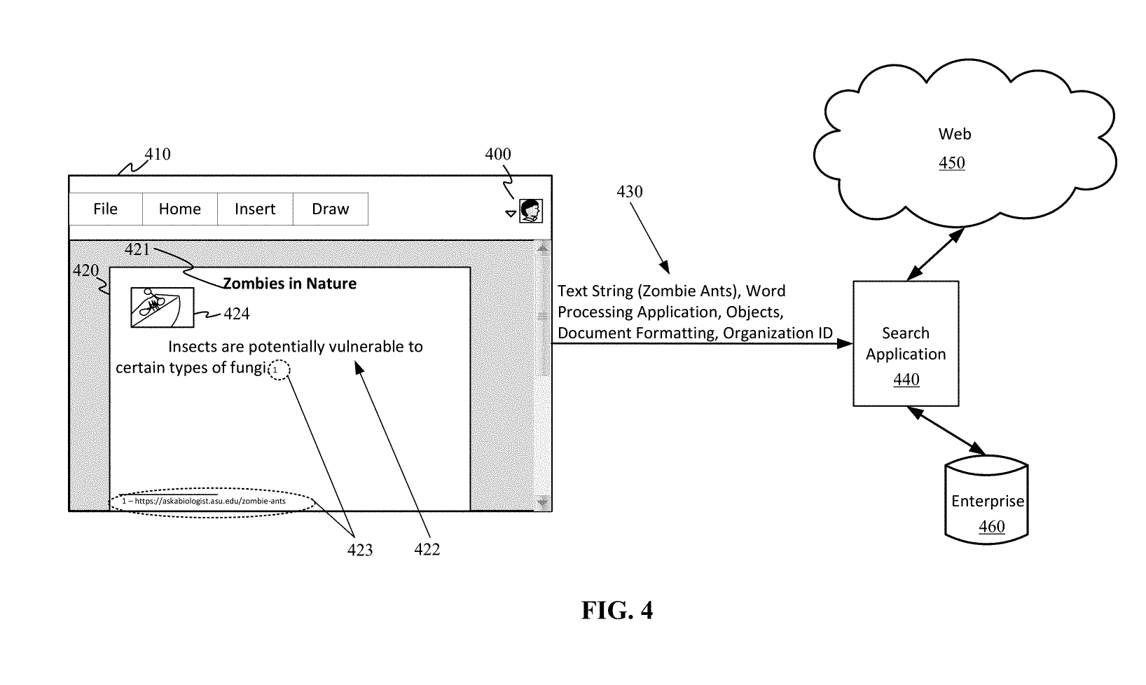

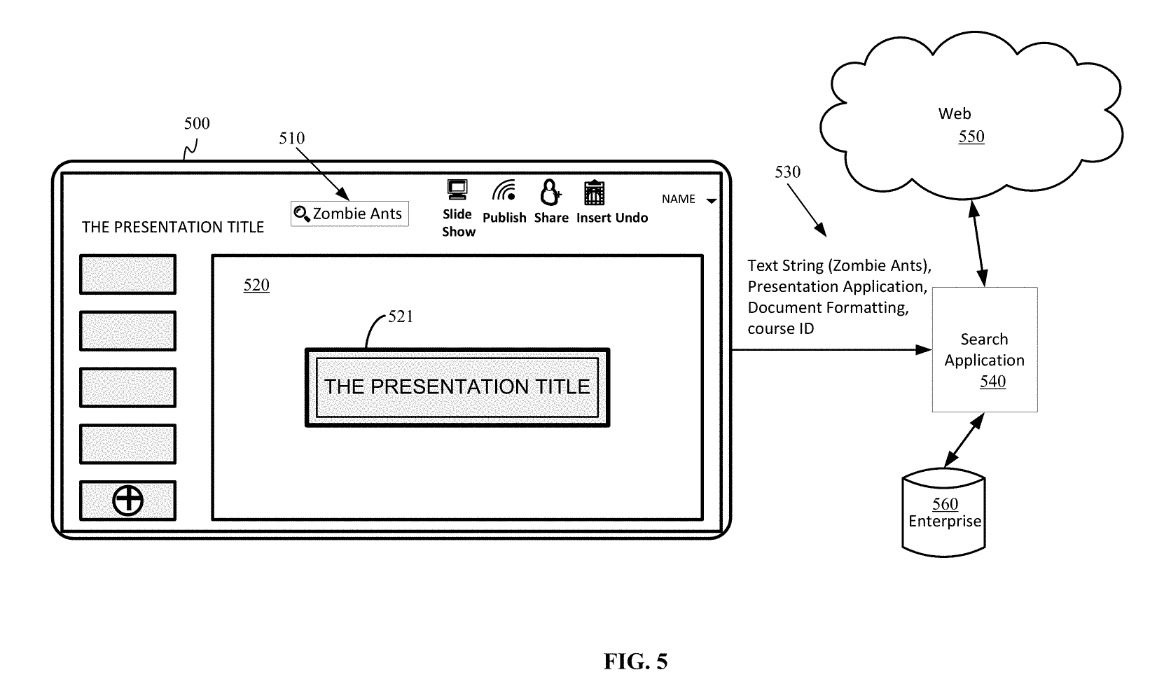

Example scenarios are illustrated in FIGS. 4, 5, and 6. FIG. 4 illustrates an example scenario for a word processing application; FIG. 5 illustrates an example scenario for a presentation application; and FIG. 6 illustrates an example scenario for a spreadsheet application.

Referring to FIG. 4, a user 400 is working on a paper in a word processing application 410. In the canvas 420 is a header 421, sentence 422, footer 423, and image 424. Although not shown, the user may have initiated an in-application search for help finding information for the paper. The service can take the contextual information and explicit or implicit user intent and formulate a query 430 to send to a search application 440, which would scope to certain sources on the web 450 or enterprise system 460. The service may determine that a relevant string for the query is “zombie ants” and the query 430 may include the text string (“zombie ants”), the type of application the user is working in (word processing application), the document formatting information (e.g., that there is the header 421, sentence 422, and footer 423), objects in the canvas (image 424, text), and organization information of the user.

In addition to there being formatting and particular objects in the canvas 420, the document formatting information can include context items (or properties) such as “near image”. Each of these things could cause a search application to search differently or respond with different content. For example, by knowing that there is an image nearby, the search application may include searches of sources with photographs, or respond with different content such as news articles or comics. The search application can understand the context and adjust the sources to be searched.

Referring to FIG. 5, a student may be preparing a presentation for class in a presentation application 500, and using a search feature 510 to input the query “zombie ants” when on the title slide 520 with a title 521. The service can take the contextual information such as the type of application the user is working in (presentation), the document formatting information (e.g., title slide 520 and title 521), along with the course identifier to formulate a query 530. The query 530 can be sent to a search application 540 that can search sources on the web 550 and/or specific to the user's school or class (e.g., enterprise system 560). Since the application type is a presentation application, the sources may be heavily directed to images and designs.

Referring to FIG. 6, the user may be working in a spreadsheet application 602 and use a search feature 604 to input the query “zombie ants”. The service can take the contextual information to formulate a query 610 to send to a search application 620, which will scope to certain sources on the web 630 or enterprise system 640. Because the query 610 indicates the source is a spreadsheet application, the search application 620 can scope the search to sources with tabular data.

In some cases, a user may input contextual information directly to a search engine and be able to get the results through a web browser. For example, a user could type into a search engine “I'm inside of presentation application” in addition to the query and the search engine would emphasize things that a user would care about more when working in a presentation application, such as images and bullet points without the application itself providing that context. Similarly, a user could say “I need information for my spreadsheet” (e.g., via a Tell Me service), and the search engine could provide the relevant type of results, such as the results with tabular data.

The mappings of context parameter to source or file type may be managed by the context-sensitive service and/or the search applications. The accuracy of the mappings can be improved through feedback mechanisms and machine learning (e.g., on the information that may be stored at resource 340 of FIG. 3A).

As mentioned above, returning to FIG. 3A, the example operating environment 300 shows service architecture and certain associated operational scenarios demonstrating various aspects of the described context-sensitive methods. In some cases, local application 302 may be considered remote from service 312 in that each are implemented on separate computing platforms. In such situations, local application 302 and service 312 may communicate by way of data and information exchanged between application platform 301 and service platform 311 over a suitable communication link or links (not shown). In other cases, the features and functionality provided by local application 302 and service 312 can be co-located or even integrated as a single application.

In other cases, service 312 may be co-located or integrated with other applications in which B communications (e.g., B1, B2) can take place, such as a search application (e.g., one or more of search engines 320, 330).

Application platform 301 is representative of any physical or virtual computing system, device, or collection thereof capable of hosting local application 302. Examples include, but are not limited to, smart phones, laptop computers, tablet computers, desktop computers, hybrid computers, gaming machines, smart televisions, entertainment devices, Internet appliances, virtual machines, wearable computers (e.g., watch, glasses), as well as any variation or combination thereof, of which computing device 700 illustrated in FIG. 7 is representative.

Local application 302 is representative of any software application, module, component, or collection thereof, in which content can be created or consumed. Examples of applications in which the context-sensitive search feature may be provided include, but are not limited to, note-taking applications, freeform digital canvases, word processing applications, spreadsheet applications, presentation applications, blogging and micro-blogging applications, social networking applications, gaming applications, and reader applications.

Local application 302 may be a browser-based application that executes in the context of a browser application. In some implementations, local application 302 may execute in the context of or in association with a web page, web site, web service, or the like. However, local application 302 may also be a locally installed and executed application, a streamed application, a mobile application, or any combination or variation thereof. Local application 302 may be implemented as a standalone application or may be distributed across multiple applications.

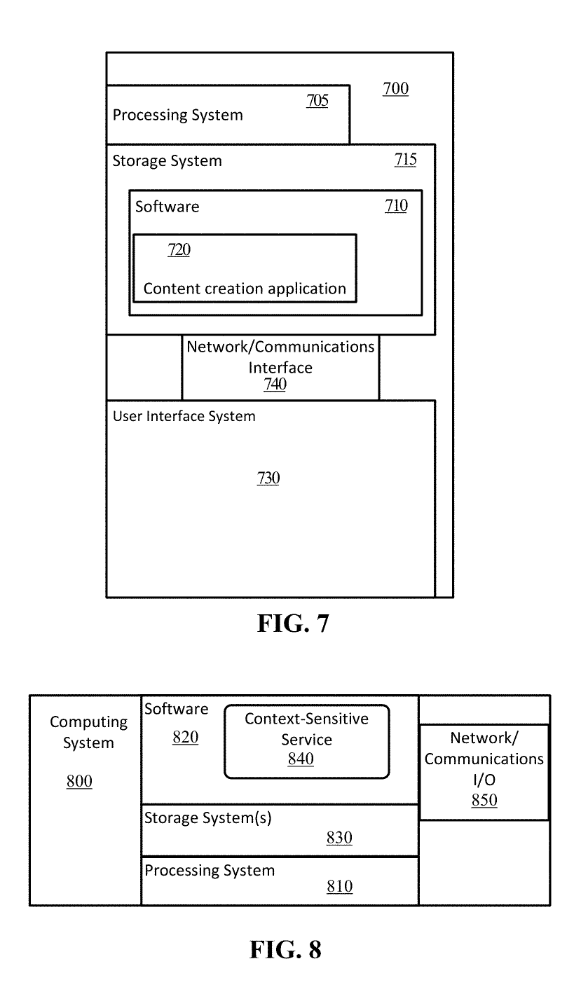

Service platform 311 is representative of any physical or virtual computing system, device, or collection thereof capable of hosting all or a portion of service 312 and implementing all or portions of process 200 described with respect to FIG. 2. Examples of service platform 311 include, but are not limited to, smart phones, laptop computers, tablet computers, desktop computers, hybrid computers, gaming machines, smart televisions, entertainment devices, Internet appliances, virtual machines, wearable computers (e.g., watch, glasses), as well as any variation or combination thereof, of which computing device 700 illustrated in FIG. 7 is representative. Further examples of service platform 311 include, but are not limited to, web servers, application servers, rack servers, blade servers, virtual machine servers, or tower servers, as well as any other type of computing system, of which computing system 800 of FIG. 8 is representative. In some scenarios, service platform 311 may be implemented in a data center, a virtual data center, or some other suitable facility.

Service 312 is any software application, module, component, or collection thereof capable of providing the context-sensitive search feature to local application 302 and communicating with search applications with structured, contextual information in a standardized format with elements available for parameters associated with context. The service 312 can include a number of REST endpoints, providing application programming interfaces (APIs). For example, the service 312 can include an API for generating a query in the standardized structure given particular context information provided with a request. In addition, queries by the service 312 to the search application(s) 320, 330 may be performed, in some cases via APIs of the search application(s) 320, 330.

FIG. 7 illustrates components of a computing device that may be used in certain embodiments described herein. Referring to FIG. 7, system 700 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen. Accordingly, more or fewer elements described with respect to system 700 may be incorporated to implement a particular computing device.

System 700 includes a processing system 705 of one or more processors to transform or manipulate data according to the instructions of software 710 stored on a storage system 715. Examples of processors of the processing system 705 include general purpose central processing units (CPUs), graphics processing units (GPUs), field programmable gate arrays (FPGAs), application specific processors, and logic devices, as well as any other type of processing device, combinations, or variations thereof. The processing system 705 may be, or is included in, a system-on-chip (SoC) along with one or more other components such as network connectivity components, sensors, video display components.

The software 710 can include an operating system and application programs, including a content creation application 720 that benefits from a context-sensitive search. Device operating systems generally control and coordinate the functions of the various components in the computing device, providing an easier way for applications to connect with lower level interfaces like the networking interface. Non-limiting examples of operating systems include WINDOWS from Microsoft Corp., APPLE iOS from Apple, Inc., ANDROID OS from Google, Inc., and the Ubuntu variety of the Linux OS from Canonical.

It should be noted that the operating system may be implemented both natively on the computing device and on software virtualization layers running atop the native device operating system (OS). Virtualized OS layers, while not depicted in FIG. 7, can be thought of as additional, nested groupings within the operating system space, each containing an OS, application programs, and APIs.

Storage system 715 may comprise any computer readable storage media readable by the processing system 705 and capable of storing software 710 including the content creation application 720.

Storage system 715 may include volatile and nonvolatile memories, removable and non-removable media implemented in any method or technology for storage of information, such as computer readable instructions, data structures, program modules, or other data. Examples of storage media of storage system 715 include random access memory, read only memory, magnetic disks, optical disks, CDs, DVDs, flash memory, magnetic cassettes, magnetic tape, magnetic disk storage or other magnetic storage devices, or any other suitable storage media.

Storage system 715 may be implemented as a single storage device but may also be implemented across multiple storage devices or sub-systems co-located or distributed relative to each other. Storage system 715 may include additional elements, such as a controller, capable of communicating with processing system 705.

The system can further include user interface system 730, which may include input/output (I/O) devices and components that enable communication between a user and the system 700. User interface system 730 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 730 may also include output devices such as display screen(s), speakers, haptic devices for tactile feedback, and other types of output devices. In certain cases, the input and output devices may be combined in a single device, such as a touchscreen display which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

A natural user interface (NUI) may be included as part of the user interface system 730. Examples of NUI methods include those relying on speech recognition, touch and stylus recognition, gesture recognition both on screen and adjacent to the screen, air gestures, head and eye tracking, voice and speech, vision, touch, hover, gestures, and machine intelligence. Accordingly, the systems described herein may include touch sensitive displays, voice and speech recognition, intention and goal understanding, motion gesture detection using depth cameras (such as stereoscopic or time-of-flight camera systems, infrared camera systems, red-green-blue (RGB) camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods).

Visual output may be depicted on the display (not shown) in myriad ways, presenting graphical user interface elements, text, images, video, notifications, virtual buttons, virtual keyboards, or any other type of information capable of being depicted in visual form.

The user interface system 730 may also include user interface software and associated software (e.g., for graphics chips and input devices) executed by the OS in support of the various user input and output devices. The associated software assists the OS in communicating user interface hardware events to application programs using defined mechanisms. The user interface system 730 including user interface software may support a graphical user interface, a natural user interface, or any other type of user interface.

Network interface 740 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

FIG. 8 illustrates components of a computing system that may be used in certain embodiments described herein. Referring to FIG. 8, system 800 may be implemented within a single computing device or distributed across multiple computing devices or sub-systems that cooperate in executing program instructions. The system 800 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 800 can include a processing system 810, which may include one or more processors and/or other circuitry that retrieves and executes software 820 from storage system 830. Processing system 810 may be implemented within a single processing device but may also be distributed across multiple processing devices or sub-systems that cooperate in executing program instructions.

Storage system(s) 830 can include any computer readable storage media readable by processing system 810 and capable of storing software 820. Storage system 830 may be implemented as a single storage device but may also be implemented across multiple storage devices or sub-systems co-located or distributed relative to each other. Storage system 830 may include additional elements, such as a controller, capable of communicating with processing system 810. Storage system 830 may also include storage devices and/or sub-systems on which data such as entity-related information is stored.

Software 820, including service 840, may be implemented in program instructions and among other functions may, when executed by system 800 in general or processing system 810 in particular, direct the system 800 or processing system 810 to operate as described herein for the context-sensitive search service, and perform operations 200.

System 800 may represent any computing system on which software 820 may be staged and from where software 820 may be distributed, transported, downloaded, or otherwise provided to yet another computing system for deployment and execution, or yet additional distribution.

In embodiments where the system 800 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 850 may be included, providing communication connections and devices that allow for communication between system 800 and other computing systems (not shown) over a communication network or collection of networks (not shown) or the air.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Embodiments may be implemented as a computer process, a computing system, or as an article of manufacture, such as a computer program product or computer-readable medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method comprising:
receiving a request for context-sensitive search results, the request comprising context information;
formulating a query in a standardized format with elements available for parameters associated with context, the query including items of the context information in appropriate elements of the query;
sending the query to one or more search applications to search appropriate file types;
receiving context-sensitive results from the one or more search applications, the context-sensitive results being of the appropriate file types;
aggregating the context-sensitive results;
ranking the context-sensitive results;
grouping the context-sensitive results;
selecting at least one of the context-sensitive results after aggregating, ranking and grouping the context-sensitive results; and
providing at least one of the context-sensitive results to a source of the request.

2. The method of claim 1, wherein the parameters associated with context comprise a parameter from the group consisting of: an IP location, what is selected in a canvas, application, state of a document, complexity of the document, objects on the canvas, user organization, command history, topic history, and document history.

3. The method of claim 2, wherein the items of the context information comprise a spreadsheet application for the application parameter or a table for the objects on the canvas parameter,
wherein the context-sensitive results from the one or more search applications are spreadsheet files and data tables.

4. The method of claim 2, wherein the items of the context information comprise a presentation application for the application parameter or an image for the objects on the canvas parameter,
wherein the context-sensitive results from the one or more search applications are images.

5. The method of claim 1, wherein the one or more search applications comprises an enterprise search system.

6. The method of claim 1, wherein the one or more search applications comprises a search engine.

7. The method of claim 1, further comprising:
formulating at least one query using the contextual information, the at least one query not being in the standardized format with the elements available for parameters associated with context;
sending the at least one query to the one or more search applications; and
receiving contextual results, the contextual results including content that are not of the appropriate file types.

8. The method of claim 1, wherein the grouping of the results comprises:
performing a clustering process according to semantic similarity in order to group the context-sensitive results into groups.

9. The method of claim 8, wherein at least one result from each group is provided to the source of the request as the at least one context-sensitive result.

10. The method of claim 8, wherein the at least one context-sensitive result provided to the source of the request is selected from a group considered most relevant.

11. A system comprising:
a processing system;
one or more computer-readable storage media; and
instructions stored on the one or more computer-readable storage media that, when executed, direct the processing system to at least:
receive a request for context-sensitive search results, the request comprising context information;
formulate a query in a standardized format with elements available for parameters associated with context, the query including items of the context information in appropriate elements of the query;
send the query to one or more search applications to search appropriate file types;
receive context-sensitive results from the one or more search applications, the context-sensitive results being of the appropriate file types;
aggregate the context-sensitive results;
rank the context-sensitive results;
group the context-sensitive results by performing a clustering process according to semantic similarity in order to group the context-sensitive results into groups;
select at least one of the context-sensitive results; and
provide at least one of the context-sensitive results to a source of the request.

12. The system of claim 11, wherein at least one result from each group is provided to the source of the request as the at least one context-sensitive result.

13. The system of claim 11, wherein the at least one context-sensitive result provided to the source of the request is selected from a group considered most relevant.

14. The system of claim 11, wherein the parameters associated with context comprise a parameter from the group consisting of: an IP location, what is selected in a canvas, application, state of a document, objects on the canvas, user organization, command history, topic history, and document history.

15. One or more computer-readable storage media having instructions stored thereon that, when executed, direct a processing system to at least:
in response to receiving a request comprising context information, formulate a query in a standardized format with elements available for parameters associated with context, the query including items of the context information in appropriate elements of the query;
wherein the parameters associated with context comprise a parameter from the group consisting of: an IP location, what is selected in a canvas, application, state of a document, objects on the canvas, user organization, command history, topic history, and document history.

16. The media of claim 15, further comprising instructions that, when executed, direct the processing system to:
send the query to one or more search applications to search appropriate file types;
receive context-sensitive results from the one or more search applications, the context-sensitive results being of the appropriate file types;
identify one or more context-sensitive results to provide to a source of the request; and
provide the one or more context-sensitive results to the source of the request.

17. The media of claim 16, wherein the instructions to identify the one or more context-sensitive results, direct the processing system to:
aggregate the context-sensitive results;
rank the context-sensitive results;
group the context-sensitive results; and
select at least one of the context-sensitive results.

18. The media of claim 16, wherein the instructions to group the context-sensitive results, direct the processing system to:
perform a clustering process according to semantic similarity in order to group the context-sensitive results into groups.

19. The media of claim 18, wherein at least one result from each group is provided to the source of the request as the one or more context-sensitive result.

20. The media of claim 18, wherein the one or more context-sensitive result provided to the source of the request is selected from a group considered most relevant.
